(19) United States
(12) Patent Application Publication
(10) Pub. No.: US 2006/0107168 A1
(43) Pub. Date: May 18, 2006

(54) Method and apparatus for transmitting/receiving virtual block information for multiple segment recovery in data network using transmission control protocol

(75) Inventor: Jeong-Sick Chang, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/245,422

(22) Filed: Oct. 7, 2005

(30) Foreign Application Priority Data
Oct. 8, 2004 (KR) 10-2004-0080600

(51) Int. Cl. H04L 1/18

(52) U.S. Cl. 714/749

(57) ABSTRACT

A method and an apparatus are provided for acknowledging a bitwise block for multiple segment recovery when data is transmitted using a TCP in a data network. A transmitter generates a BBACK including virtual block information consisting of a bit array, each bit of which represents a virtual block of predetermined size, and transmits the BBACK. Each bit is set to ‘1’ when a corresponding virtual block overlaps a loss block of a physical stream. A receiver then receives the BBACK and retransmits a virtual block represented by a bit ‘1’ of the bit array if all of the bits of the bit array are not ‘0’.

### CROSS-REFERENCE TO RELATED APPLICATIONS

This application claims the benefit under 35 U.S.C. §119(a) of Korean Patent Application No. 10-2004-0080600 entitled “Method And Apparatus For Transmitting/Receiving Virtual Block Information For Multiple Segment Recovery In Data Network Using Transmission Control Protocol”, filed in the Korean Intellectual Property Office on Oct. 8, 2004, the entire disclosure of which is hereby incorporated by reference.

### BACKGROUND OF THE INVENTION

1. Field of the Invention

The present invention relates to data network communication. More particularly, the present invention relates to a method and an apparatus for acknowledging a bitwise block for multiple segment recovery when data is transmitted using a Transmission Control Protocol (hereinafter referred to as ‘TCP’) in a data network.

2. Description of the Related Art

A TCP has been developed for congestion control (hereinafter referred to as ‘congestion-conscious’) in a data network such as the shared Internet. A TCP congestion-conscious mechanism consists of slow start, congestion avoidance, fast retransmit and fast recovery algorithms. The conventional TCP congestion-conscious mechanism has been designed considering a case wherein only one data unit (hereinafter referred to as ‘segment’) is lost in a window of a transmitter. Thus, when multiple segment loss occurs in one window, normal operations are not achieved.

There have been many attempts to improve TCP throughput for such multiple segment loss. These include the TCP New Reno modification and TCP Selective Acknowledgment (hereinafter referred to as ‘SACK’). The TCP New Reno modification saves the maximum sequence number of octet blocks which are successfully transmitted before the fast retransmit and the fast recovery. The TCP New Reno modification further notifies the lower sequence number when there is partial Acknowledgment (hereinafter referred to as ‘ACK’), so that it can been seen that more segments have been lost. The existing TCP (Reno) requires a time for applying a duplicate ACK per loss segment because it performs the fast retransmit and the fast recovery whenever it receives the duplicate ACK. In contrast with this, since the TCP New Reno modification continues the fast recovery until all the loss segments are successfully received, it requires only one Round Trip Time (hereinafter referred to as ‘RTT’) for the recovery of one segment.

The TCP SACK has been devised in order to recover multiple segment loss during one RTT. Here, an ACK indicates that recent octet blocks have been successfully received. The octet blocks have variable sizes and are expressed by two sequence numbers (each being 8 bytes in length) representing a block-starting octet and an octet next to a block-ending octet. Since the length of TCP option bits is limited to 40 bytes, the maximum number of discontinuous octet blocks is 4. A transmitter may attempt to recover all losses within one RTT.

A TCP throughput is measured by a usefulness of a link which can be managed within one window. For window management, the size of a window must be exactly adjusted according to the conditions of a network and a communication partner. In the recovery of multiple segment loss within one window, the TCP New Reno modification reduces the excess frequency of fast recoveries in the existing TCP (Reno) by half. Also, the TCP SACK reduces the overall recovery time (equal to an integer times RTT) of the TCP New Reno modification to a single RTT. However, the TCP SACK has a problem in that it requires a large number of option bits as compared with little block information. For example, if additional information is included, 34 bytes are required for the maximum 4 discontinuous blocks.

Accordingly, a need exists for a system and method for effective and efficient multiple segment recovery in a data network using a TCP.

### SUMMARY OF THE INVENTION

Accordingly, the present invention has been made to substantially solve the above-mentioned and other problems occurring in the prior art, and an object of the present invention is to provide a method and an apparatus for operating a TCP ACK in order to recover multiple segment loss within one RTT by a transmitter.

A further object of the present invention is to provide a method and an apparatus for providing an abstract from a window of a receiver on a bit array, each bit of which represents a virtual octet block of segment size.

To accomplish these objects, in accordance with one aspect of the present invention a method is provided for transmitting virtual block information for multiple segment recovery in a data network using a TCP, the method comprising the steps of generating a bitwise block ACK including virtual block information consisting of a bit array, each bit of which represents a virtual block of predetermined size and each bit being set to ‘1’ when a corresponding virtual block overlaps a loss block of a physical stream and transmitting the bitwise block ACK.

In accordance with another aspect of the present invention, a method is provided for receiving virtual block information for multiple segment recovery in a data network using a TCP, the method comprising the steps of receiving a bitwise block ACK including virtual block information consisting of a bit array, each bit of which represents a virtual block of predetermined size and each bit being set to ‘1’ when a corresponding virtual block overlaps a loss block of a physical stream, determining if all the bits of the bit array are ‘0’ and retransmitting a virtual block represented by bit ‘1’ of the bit array if all the bits of the bit array are not ‘0’.

In accordance with another aspect of the present invention, an apparatus is provided for transmitting/receiving virtual block information for multiple segment recovery in a data network using a TCP, the apparatus comprising a first network unit for generating a bitwise block ACK including virtual block information consisting of a bit array, each bit of which represents a virtual block of predetermined size, and transmitting the bitwise block ACK, and each bit being set to ‘1’ when a corresponding virtual block overlaps a loss block of a physical stream. The apparatus further comprises a second network unit for receiving the bitwise block ACK, determining if all the bits of the bit array are ‘0’ and retransmitting a virtual block represented by bit ‘1’ of the bit array if all the bits of the bit array are not ‘0’.

### BRIEF DESCRIPTION OF THE DRAWINGS

The above and other objects, features and advantages of the present invention will become more apparent from the following detailed description taken in conjunction with the accompanying drawings, in which:

FIG. 1 is a view illustrating a data network in accordance with an exemplary embodiment of the present invention;

FIG. 2 is a view illustrating an exemplary protocol stack of the data network in FIG. 1;

FIG. 3 is a view illustrating an exemplary IP packet which can be transmitted and routed in an IP layer in FIG. 2;

FIG. 4 is a view illustrating an example of a bit array in accordance with an exemplary embodiment of the present invention;

FIG. 5 is a view illustrating a format of a bitwise block ACK (BBACK) which is included in an option field of a TCP packet in accordance with an exemplary embodiment of the present invention;

FIG. 6 is a view illustrating transmission/reception of segments using the BBACK according to exemplary embodiments of the present invention;

FIG. 7 is a flowchart illustrating TCP acknowledgment operations of a transmitting side-network unit (transmitter) in accordance with an exemplary embodiment of the present invention;

FIG. 8 is a flowchart illustrating TCP acknowledgment operations of a receiving side-network unit (receiver) in accordance with an exemplary embodiment of the present invention;

FIG. 9 is a Table for comparing the BBACK of exemplary embodiments of the present invention with an existing SACK; and

FIG. 10 is a view illustrating retransmission of virtual blocks according to the BBACK of exemplary embodiments of the present invention.

Throughout the drawings, like reference numerals will be understood to refer to like parts, components and structures.

### DETAILED DESCRIPTION OF THE EXEMPLARY EMBODIMENTS

Hereinafter, exemplary embodiments of the present invention will be described with reference to the accompanying drawings. It should be noted that same or similar components are designated by same or similar reference numerals although they are illustrated in different drawings. Also, in the following description, detailed descriptions of known functions and configurations incorporated herein are omitted for clarity and conciseness. Furthermore, terms to be described below are defined in consideration of functions in embodiments of the present invention, and may vary with intentions or customs of users or operators. Therefore, the definitions of such terms are preferably to be based on the corresponding contents over the whole specification.

Embodiments of the present invention described below provide acknowledgment information of received segments by using a bit array and an individual ACK. Here, each bit of the bit array represents a virtual block of predetermined size. Basically, 32 virtual blocks are expressed using fixed size, for example, only 4 bytes (32 bits).

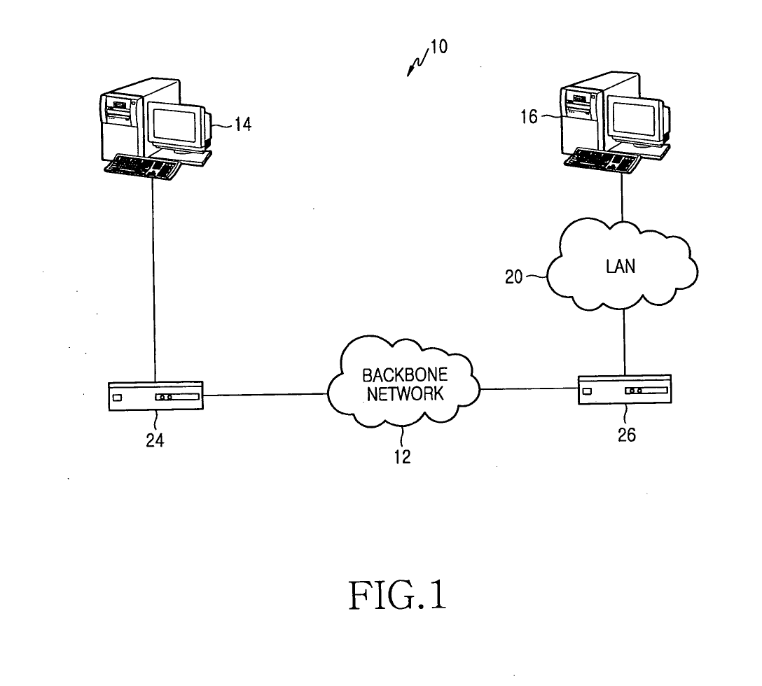

FIG. 1 illustrates a data network in accordance with an exemplary embodiment of the present invention. In the drawing, reference numeral ‘10’ designates the data network.

Referring to FIG. 1, the data network 10 comprises a backbone network 12 such as the Internet, a first network unit 14 and a second network unit 16. The backbone network 12 may be the shared Internet that is accessible by a plurality of users that are capable of communications. Additionally, there are a plurality of Local Area Networks (hereinafter referred to as ‘LAN’) 20 such as a private network. Data packets are transferred between the first network unit 14 and the second network unit 16 over the backbone network 12. Shared network addresses which are identified in the data network may be allocated to the network units 14 and 16. A data channel between the network units 14 and 16 may comprise a plurality of routers or gateways 24 and 26. Although not shown, the network units 14 and 16 are not limited to network units of a packet data network and, for example, may be moving nodes that are accessible to a wireless access network.

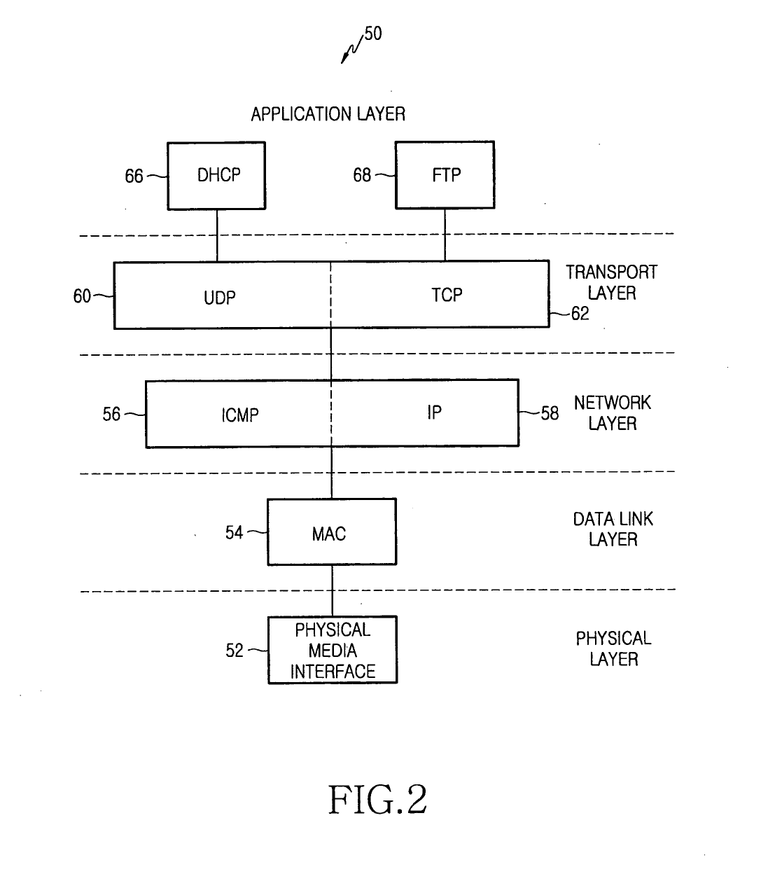

FIG. 2 illustrates a protocol stack of the data network in FIG. 1. In the drawing, reference numeral ‘50’ designates a protocol stack according to an Open System Interconnection (OSI) model. As well known to those skilled in the art, the OSI model comprises 7 layers, that is, a physical layer, a data link layer, a network layer, a transport layer, a session layer (not shown), a presentation layer (not shown) and an application layer. Here, the physical layer transmits bits through a communication link and is free of data errors. The network layer transmits and routes data packets.

Referring to FIG. 2, the lowest physical layer includes a physical media interface 52 such as a wire, a coaxial cable or an electromagnetic wave transmitting/receiving means. The data link layer is called a Medium Access Control (hereinafter referred to as ‘MAC’) layer 54. The MAC layer 54 controls transmission media access through the physical layer. An upper layer of the data link layer is an Internet Protocol (hereinafter referred to as ‘IP’) layer 58. The IP layer 58 may be usually regarded as belonging to a third layer of the OSI model, that is, the network layer. The IP layer 58 takes charge of message addressing and routing of traffic.

An Internet Control Message Protocol (hereinafter referred to as ‘ICMP’) layer 56 is used for network management. Major functions of the ICMP layer 56 include error reporting, reachability testing such as pinging, congestion-conscious, route-change notification, performance, subnet addressing and the like.

An upper layer of the IP layer 58 and the ICMP layer 56 is a User Datagram protocol (hereinafter referred to as ‘UDP’) layer 60. The UDP layer 60 may be usually regarded as belonging to a fourth layer of the OSI model, that is, the transport layer. The UDP provides an access mode for communications of datagrams. Also, the transport layer includes a connection-oriented TCP layer 62. The TCP layer 62 will be described in greater detail below.

An upper layer of the transport layer is the application layer. The session layer and the presentation layer are not shown in the drawing. A Dynamic Host Configuration Protocol (hereinafter referred to as ‘DHCP’) layer 66, a File Transfer Protocol (hereinafter referred to as ‘FTP’) layer 68 and so forth, are located in the application layer. The DHCP layer 66 is a protocol for transferring configuration information to a host on the IP layer 58, and the FTP layer 68 is a protocol used for downloading files and the configuration information.

It should be noted that the protocol stack shown in FIG. 2 is only an example to which embodiments of the present invention may be applied, and application fields of embodiments of the present invention are not limited to those of FIG. 2. Rather, embodiments of the present invention may be applied to all kinds of communications based on the IP and the TCP.

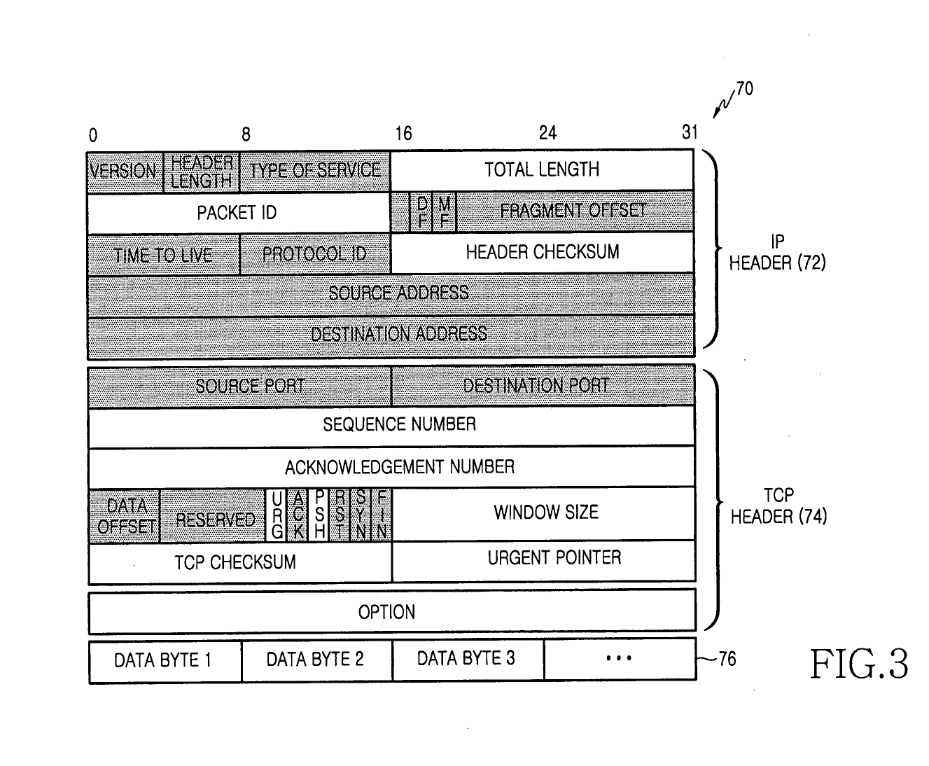

FIG. 3 illustrates an IP packet which is transmitted and routed in the IP layer 58 in FIG. 2. In the drawing, reference numeral ‘70’ designates the IP packet.

Referring to FIG. 3, the IP packet 70 comprises an IP header field 72, a TCP header field 74 and a payload field 76. The payload field 76 usually includes data being transferred from one network unit to another network unit. Otherwise, the payload field 76 may include ICMP network management messages or data packets of other protocols such as the UDP, the TCP, the FTP and the DHCP.

A brief description of the information segments of the IP header 72 is given below. From left to right, a protocol version of 4 bits represents a format of an Internet header. Hereinafter, version 4 format disclosed in RFC 791 will be described. Next, a ‘Header Length’ having 4 bits is the length of the Internet header and indicates the beginning of data. Next, a ‘Type of Service’ is 8-bit information representing quality of service which is desired in view of delay, reliability and throughput. Next, a ‘Total Length’ having 16 bits is the length of a packet (header and data) measured by the octet.

A ‘Packet ID’ is a 16-bit identification value which a transmitting node allocates in order to assemble fragments of a datagram. Of three flags having 1 bit, respectively, a first redundant bit is set to ‘0’. A ‘DF’, which is a second bit, represents whether or not it is a fragment, and an ‘MF’, which is a third bit, represents whether or not it is the last fragment. Next, a ‘Fragment Offset’ having 13 bits represents where a corresponding fragment is positioned in the datagram.

A ‘Time To Live’ (TTL) having 8 bits represents a maximum time, during which a corresponding datagram remains. Next, a ‘Protocol ID’ having 8 bits represents a protocol, in this case, a TCP, used in a data portion of a datagram. A ‘Header Checksum’ having 16 bits is error correction information for only the header.

A ‘Source Address’ and ‘Destination Address’ represent 32-bit IP addresses of a source and a destination, respectively.

A brief description of the TCP header 74 segments is now given below. From left to right, a ‘Source Port’ and ‘Destination Port’ represent 16-bit port numbers of a source and a destination, respectively. A ‘Sequence Number’ (SN) having 32 bits represents the sequence number of a first octet included in the payload field 76. An ‘Acknowledgment Number’ having 32 bits is the sequence number of a next sequence which is expected to be received in the transmitting node.

A ‘Data Offset’ having 4 bits represents the length of the TCP header 74 in 32 bit word increments. Next, ‘Reserved’ having 6 bits must preferably be set to ‘0’. Control bits, that is, ‘URG’, ‘ACK’, ‘PSH’, ‘RST’, ‘SYN’ and ‘FIN’ are 6 bits used for determining types of acknowledgments in case of a standardized TCP ACK. The meanings of the control bits are as follows:

URG (Urgent Pointer): represents whether or not an urgent pointer field is valid;

ACK (Acknowledgment): represents whether or not a packet configures a response;

PSH (Push): represents whether or not a ‘push’ function has been Required;

RST (Reset): represents whether or not an access reset is required;

SYN (Synchronization): synchronizes the sequence numbers with each Other; and

FIN (Final): represent that data to be transmitted does not exist any more.

A ‘Window Size’ having 16 bits represents a maximum size of the sequence numbers capable of being accommodated in the transmitting node. A ‘TCP Checksum’ having 16 bits is a checksum of the header and the data. Next, an ‘Urgent Pointer’ having 16 bits represents the sequence number of continued urgent data. Next, an ‘Option’ includes various information settable by users and, in particular, includes a bitwise block ACK consisting of a bit array and an individual ACK for virtual octet blocks according to an exemplary embodiment of the present invention.

Since the TCP has a stream-oriented flow control mechanism, a transmitter usually does not store any history about previously transmitted segments, and can know only the starting sequence number, window size and the sequence number of an octet block which is being transmitted. The TCP does not transmit only one segment-sized block starting from the cumulative sequence number, so a retransmitted segment may not be the same as a loss segment. Here, the cumulative segment number refers to the sequence number of a first duplicatedly transmitted segment, that is, a first non-acknowledged segment.

Embodiments of the present invention operate to a large extent based on a bitwise block ACK (hereinafter referred to as ‘BBACK’). First, a receiver notifies a transmitter of a current status of a receiver's window, and the transmitter is effectively synchronized with the receiver's window. Then, virtual block information of a bit array structure is generated from the receiver's window. Each bit of the bit array represents one virtual block having a predetermined size. The size of the virtual block is preferably one segment size, but may be one or more octets according to conditions of a network.

A Least Significant Bit (hereinafter referred to as ‘LSB’) of the bit array represents a virtual block starting from the sequence number of a first non-acknowledged (lost) segment, that is, the cumulative sequence number, and continued next virtual blocks are mapped in sequence to upper bits of the bit array. The size of the virtual blocks is so adjusted as to cover the whole window having a variable size. If any virtual block is at least partially the same as (that is, overlaps) a physically lost portion, the value of a bit mapped to the virtual block is ‘1’ and if not, the value is ‘0’. Setup of the virtual blocks includes all of the physical loss blocks.

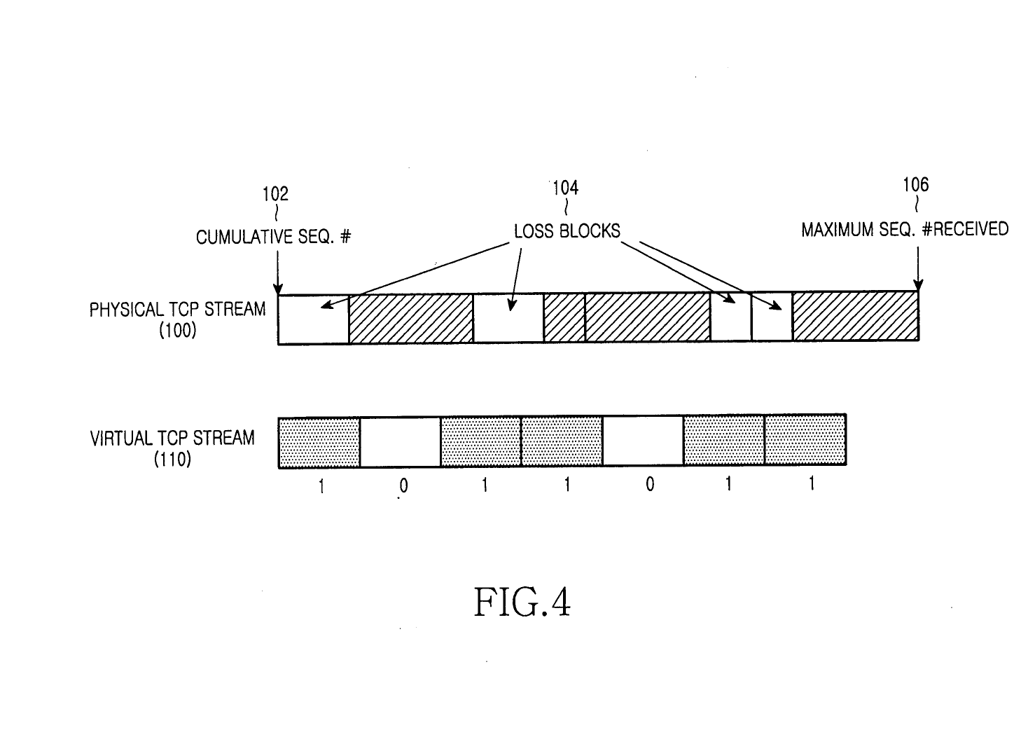

FIG. 4 illustrates an example of the bit array in accordance with an exemplary embodiment of the present invention.

As shown in the drawing, a physical (that is, actual) TCP stream 100 comprises a series of TCP segments having various sizes. The TCP segments may have various sizes, but the starting sequence number of the TCP stream 100 is fixed to the sequence number of a first non-acknowledged segment, that is, the cumulative sequence number 102. The TCP stream 100 comprises a plurality of discontinuous loss blocks 104, and the last block has the maximum sequence number 106.

A virtual TCP stream 110 corresponding to the physical TCP stream 100 comprises a series of virtual blocks having a predetermined size. Bits of the bit array, which represent the respective virtual blocks, are set to ‘1’ when a corresponding virtual block overlaps at least a part of the loss block 104. Thus, the bit array for the TCP stream 100 is set to ‘1011011’. The size of the bit array may be dynamically determined according to various network conditions.

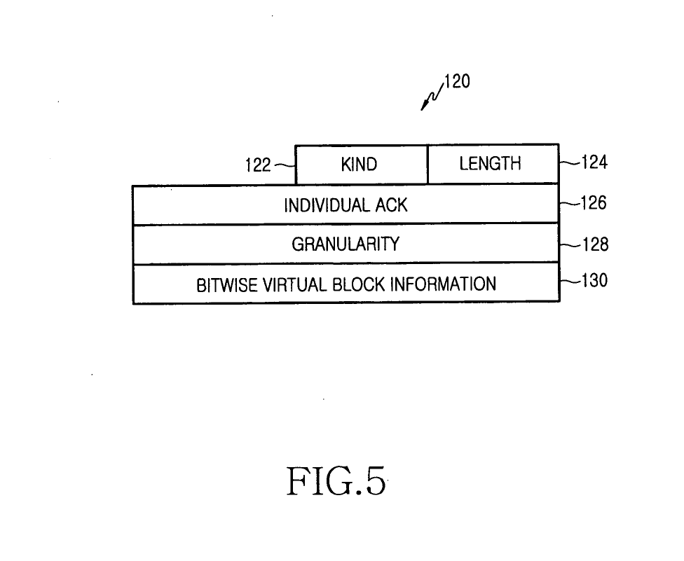

FIG. 5 illustrates a format of a BBACK which is included the option field of the TCP packet in accordance with an exemplary embodiment of the present invention. Here, a BBACK 120 having a basic size of 12 bytes is illustrated. In the drawing, reference numerals ‘122’ and ‘124’ designate portions representing a kind and length of the BBACK, respectively.

Referring to FIG. 5, the first 4 bytes following the kind 122 and the length 124 are an individual ACK 126 indicating that a corresponding segment is normally (that is, without loss) received. The individual ACK 126 is the sequence number of the corresponding segment, and corresponds to a cumulative ACK. The next 4 bytes are granularity information 128 representing the size of a virtual block. The last 4 bytes comprise a BBACK 130, and the BBACK comprises a bit array which represents whether or not each of the virtual blocks constituting a virtual TCP stream of predetermined size is lost.

Here, a bit array having a size of 4 bytes (1 word) is illustrated, but it is obvious that the size of the bit array may extend beyond 4 bytes according to network conditions. That is, the size of the virtual block information 130 can be so adjusted as to support any size of a receiver's window. At this time, if the bit array of 4 bytes included in the BBACK having a basic size of 12 bytes is referred to as ‘a virtual block word’, a maximum of 7 virtual block words may be included in the virtual block information 130 according to the following Equation (1) because the length of the option field is limited to 40 bytes and the kind field and the length field have a length of 2 bytes:

$$\frac{40 ( option field ) - 2 ( kind , length ) - 8 ( individual ACK , granularity )}{4} > 7 \qquad ( 1 )$$

In this manner, the BBACK can express bitwise blocks with fine granularity.

If a transmitter receives virtual block information of the BBAXK, physical blocks, which cover virtual blocks corresponding to bit ‘1’ of the virtual block information, are retransmitted. According to internal division schemes of memory allocation, the transmitter may also retransmit non-lost physical blocks such that the entire loss physical blocks can be recovered based on the virtual blocks. Even if the segment size is maintained to the same size in one TCP session, the size of the virtual block can be adjusted. Thus, if the size of the virtual block is appropriately adjusted, a waste of traffic due to the retransmission of the non-lost blocks can be minimized. Of course, retransmission of the first block starting from the cumulative sequence number is not a waste of traffic.

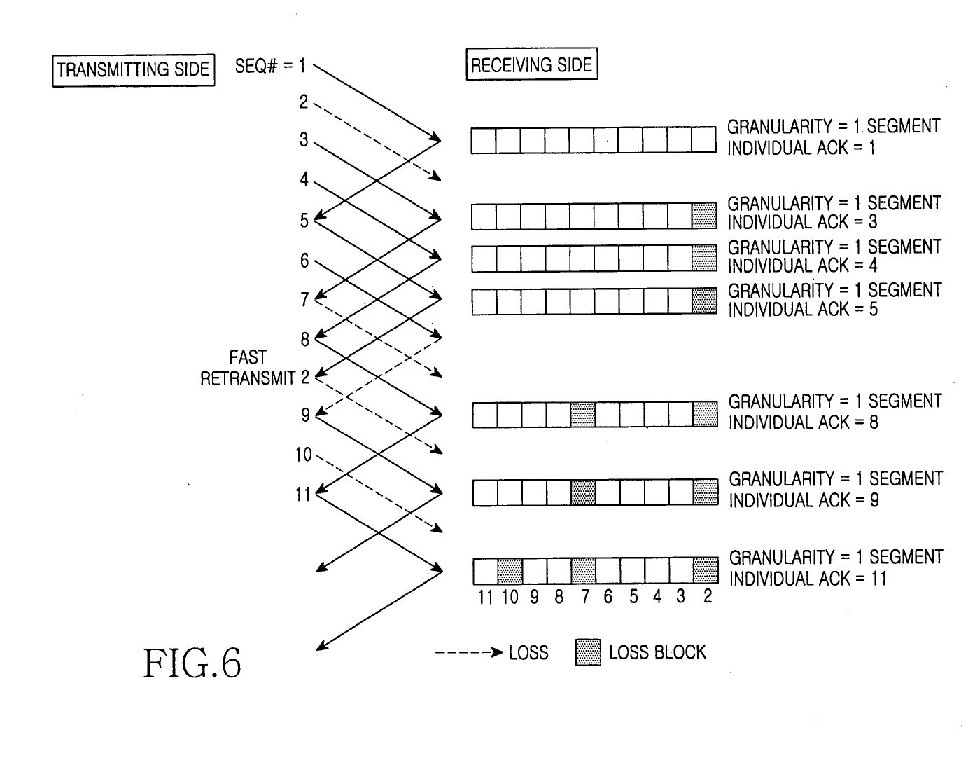

FIG. 6 illustrates a transmission/reception of segments using the BBACK according to embodiments of the present invention. Here, a detailed description of a recovery mechanism is omitted for clarity and conciseness. In an example shown in the drawing, granularity of the BBACK is ‘1 segment’. This indicates that the recovery mechanism is implemented in 1 segment units. The entire virtual block information of the BBACK represents a status of a receiver's window. Thus, a transmitter can know segments which are discontinuously lost during one RTT.

Referring to FIG. 6, an ACK of segment #6 and segment #7 are lost, but an individual ACK of segment #8 is exactly transferred to the transmitter along with virtual block information including a bit array for segment #2 to segment #8. Also, segment #2 fails in retransmission, but the transmitter can recognize an individual ACK of segment #9 received after the retransmission of segment #2. Each individual ACK notifies what a final segment normally received by a receiver is, and enables the transmitter to detect segment duplication.

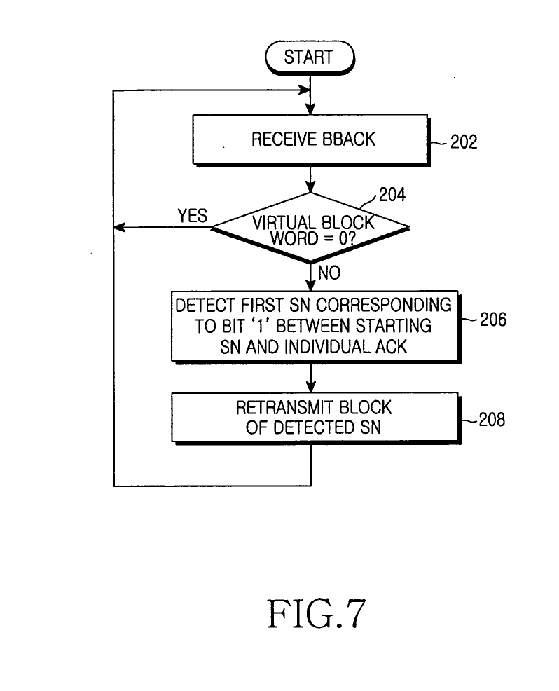

FIG. 7 is a flowchart illustrating TCP acknowledgment operations of a transmitting side-network unit (transmitter) in accordance with an exemplary embodiment of the present invention.

Referring to FIG. 7, in step 202, a BBACK is received at a transmitter. The BBACK includes an individual ACK and virtual block information. In step 204, the transmitter determines if all of the bits of the virtual block information are ‘0’. If the virtual block information is ‘0’, the transmitter returns to step 202.

However, if all of the bits of the virtual block information are not ‘0’, in step 206, the transmitter detects the sequence number of a virtual block corresponding to bit ‘1’ of a bit array between the starting sequence number (that is, the cumulative sequence number) and the sequence number corresponding to the individual ACK. In step 208, a physical block including a segment of the detected sequence number is retransmitted.

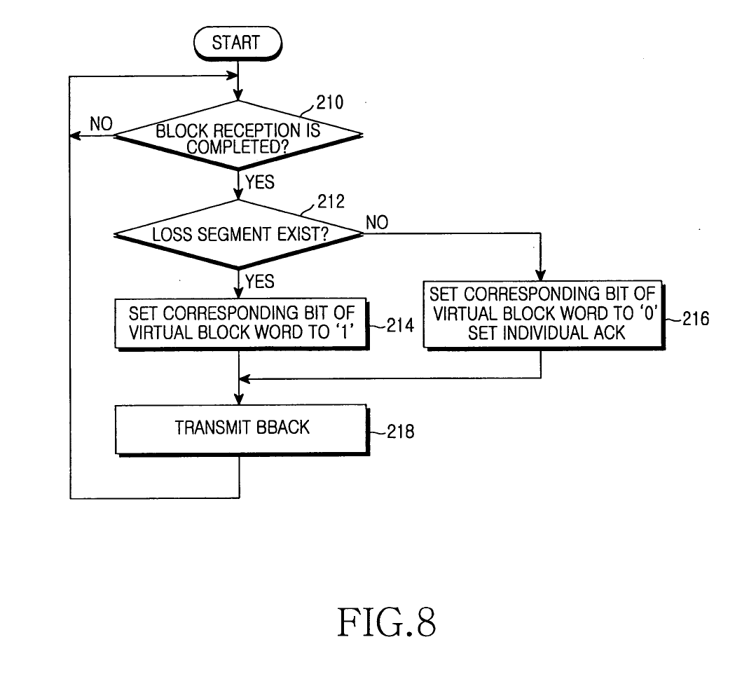

FIG. 8 is a flowchart illustrating TCP acknowledgment operations of a receiving side-network unit (receiver) in accordance with an exemplary embodiment of the present invention.

Referring to FIG. 8, in step 210, a receiver waits until segments corresponding to at least one virtual block are all received. In step 212, the receiver determines if at least a part of loss segments exists in the received virtual block, that is, the received virtual block overlaps a loss portion. If the received virtual block overlaps the loss portion, in step 214, the receiver sets a bit corresponding to the virtual block in a bit array of virtual block information starting from the starting sequence number known by the receiver to ‘0’. However, if the received virtual block does not overlap the loss portion, in step 216, the receiver sets the bit corresponding to the virtual block in the bit array of the virtual block information to ‘0’. In step 218, the receiver sets the individual ACK to the sequence number of a segment which is finally received without loss, and transmits a BBACK including the individual ACK and the virtual block information to a transmitter.

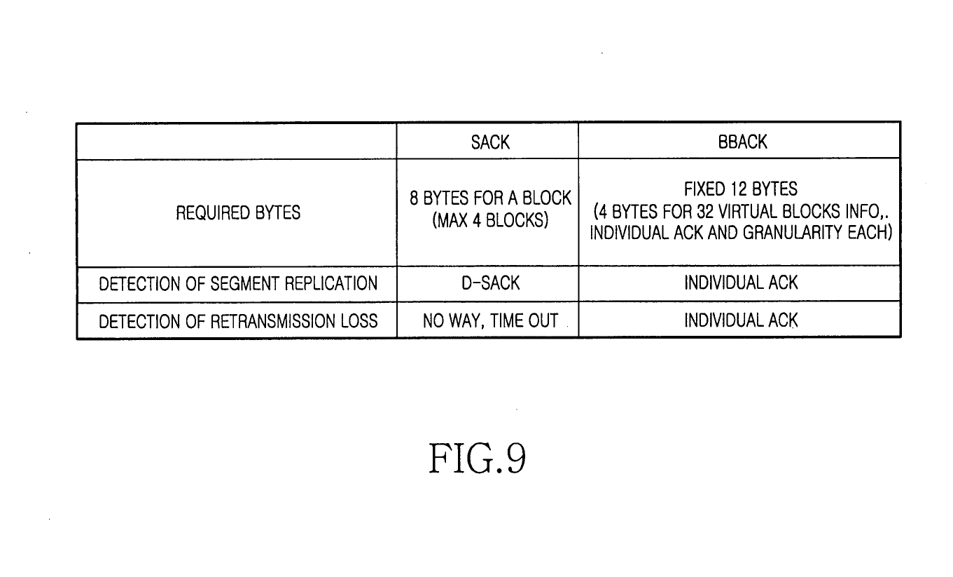

As stated above, the BBACK according to embodiments of the present invention can cover problems and functions of the TCP (Reno), the TCP New Reno modification and the TCP SACK. The TCP (Reno) requires the overall recovery procedure, that is, the fast recovery and the fast retransmit for every one segment, and the TCP New Reno modification maintains a state of the fast recovery until all segments are recovered. Consequently, the TCP (Reno) and the TCP New Reno modification waste one RTT until each segment is recovered. This is because the transmitter does not know about the loss of a next segment before the ACK of a previously recovered segment is received. The TCP SACK and the BBACK can recover multiple segment loss during one RTT. The Table of FIG. 9 illustrates functions of the BBACK in comparison with the TCP SACK.

Referring to FIG. 9, whereas the SACK requires ACK information of 8 bytes per one block, the BBACK requires only fixed 12 bytes (an individual ACK, granularity information and virtual block information having 4 bytes, respectively). In order to detect segment duplication, the SACK needs a more extended technology called a Detecting SACK (hereinafter referred to as ‘D-SACK’) and has no way to detect retransmission loss. However, the BBACK can detect both the segment duplication and the retransmission loss by using the individual ACK. Here, the D-SACK, an extended SACK, requires 8 additional bytes for representing the segment duplication and does not provide the individual ACK enabling the transmitter to detect duplicatedly transmitted blocks and segments.

The TCP SACK abbreviates a transmitting side's status in which the transmitter retransmits a loss segment. Thus, if the retransmit segment is lost, the transmitter has no way to recognize the loss. This is because the TCP SACK provides only receiver's status information. In contrast with this, the individual ACK of embodiments of the present invention solves this problem. That is, by the individual ACK, the transmitter can know the status of a next segment transmitted after the retransmission of the loss segment. If the transmitter receives an ACK for the next segment, the loss segment fails in retransmission. In conclusion, the SACK requires a minimum of 8 bytes to a maximum of 32 bytes, but the BBACK of embodiments of the present invention requires only a fixed 12 bytes while providing all functions.

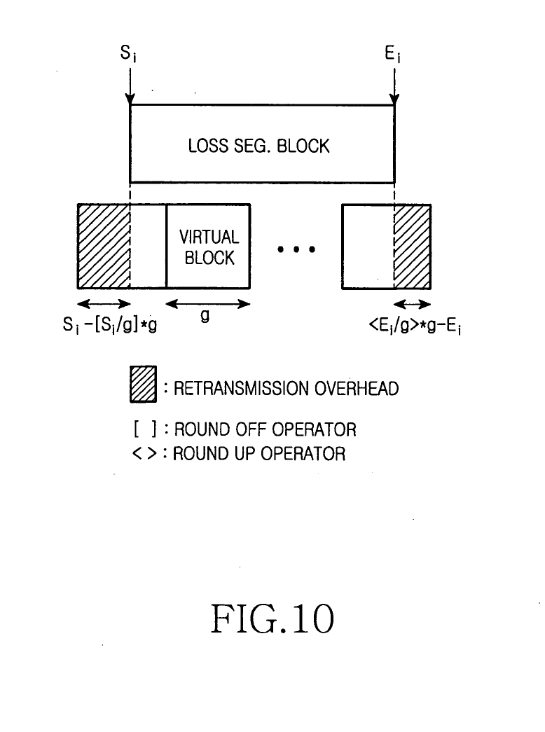

The TCP uses a stream-oriented flow control structure, so embodiments of the present invention may have a little overhead during retransmission of a loss segment. That is, if all the loss segments are required to be retransmitted, some octets may be unnecessarily retransmitted. FIG. 10 illustrates the retransmission of virtual blocks according to the BBACK of embodiments of the present invention. Here, ‘Sᵢ’ is a starting sequence number offset of an i-th segment from the last cumulative ACK, ‘Eᵢ’ is an ending sequence number offset of the i-th segment from the last cumulative ACK, and ‘g’ is the size of a virtual block. Thus, retransmission overhead can occur by as much as the sum of,
‘Sᵢ−[Sᵢ/g]*g’+‘<Eᵢ/g>*g−Eᵢ’
Here, ‘[]’ is a round-off operator and ‘<>’ is a round-up operator.

Referring to FIG. 10, a maximum overhead may be twice the size of one virtual block and is on average, the size of one virtual block. This occurs when virtual blocks are not exactly synchronized with segment blocks. Therefore, if the size of the virtual block is equalized with that of the physical segment block, virtual block information exactly indicates loss segments, and thus, a recovery operation in the segment unit does not cause the overhead. Otherwise, if the transmitter stores history information for previously transmitted segments, the recovery operation can be performed in the unit of the physically transmitted segment.

As described above, in embodiments of the present invention, a bit array, which represents whether or not a virtual TCP stream corresponding to a physical TCP stream is lost, is transmitted from a receiver to a transmitter by using an option field of a TCP header so that a recovery operation can be rapidly and exactly performed with only offset information having a relatively smaller quantity than that of block information, and such that it is possible to detect duplication and retransmission loss of segments.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for transmitting virtual block information for multiple segment recovery in a data network using a TCP, the method comprising the steps of:
generating a bitwise Block Acknowledge (BBACK) including virtual block information comprising a bit array, each bit of which represents a virtual block of a predetermined size and wherein each bit is set to ‘1’ when a corresponding virtual block overlaps a loss block of a physical stream; and
transmitting the BBACK.

2. The method as claimed in claim 1, wherein the size of the virtual block is the same as that of one segment on the physical stream.

3. The method as claimed in claim 1, wherein the size of the virtual blocks is determined to cover an overall size of a window for TCP operations.

4. The method as claimed in claim 1, wherein the BBACK further comprises an individual ACK representing the sequence number of a segment which is finally received without loss.

5. The method as claimed in claim 4, wherein the bit array represents virtual blocks corresponding to segments from the sequence number of a first non-acknowledged segment to the individual ACK.

6. The method as claimed in claim 1, wherein the BBACK further comprises a field representing a kind and length of the BBACK, and granularity information representing a size of the virtual block.

7. The method as claimed in claim 1, wherein the BBACK is included in an option field of a TCP header.

8. A method for receiving virtual block information for multiple segment recovery in a data network using a TCP, the method comprising the steps of:
receiving a bitwise block Acknowledge (BBACK) including virtual block information comprising a bit array, each bit of which represents a virtual block of a predetermined size and wherein each bit is set to ‘1’ when a corresponding virtual block overlaps a loss block of a physical stream;
determining if all of the bits of the bit array are ‘0’; and
retransmitting a virtual block represented by a bit ‘1’ of the bit array if all of the bits of the bit array are not ‘0’.

9. The method as claimed in claim 8, wherein the size of the virtual block is the same as that of one segment on the physical stream.

10. The method as claimed in claim 8, wherein the size of the virtual blocks is determined to cover an overall size of a window for TCP operations.

11. The method as claimed in claim 8, wherein the BBACK further comprises an individual ACK representing the sequence number of a segment which is finally received without loss.

12. The method as claimed in claim 11, wherein the bit array represents virtual blocks corresponding to segments from the sequence number of a first non-acknowledged segment to the individual ACK.

13. The method as claimed in claim 8, wherein the BBACK further comprises a field representing a kind and length of the BBACK, and granularity information representing a size of the virtual block.

14. The method as claimed in claim 8, wherein the BBACK is included in an option field of a TCP header.

15. An apparatus for transmitting/receiving virtual block information for multiple segment recovery in a data network using a TCP, the apparatus comprising:
a first network unit for generating a bitwise block ACK (BBACK) including virtual block information comprising a bit array, each bit of which represents a virtual block of predetermined size, and for transmitting the BBACK, each bit being set to ‘1’ when a corresponding virtual block overlaps a loss block of a physical stream; and
a second network unit for receiving the BBACK, determining if all of the bits of the bit array are ‘0’, and for retransmitting a virtual block represented by a bit ‘1’ of the bit array if all of the bits of the bit array are not ‘0’.

16. The apparatus as claimed in claim 15, wherein the size of the virtual block is the same as that of one segment on the physical stream.

17. The apparatus as claimed in claim 15, wherein the size of the virtual blocks is determined to cover an overall size of a window for TCP operations.

18. The apparatus as claimed in claim 15, wherein the BBACK further comprises an individual ACK representing the sequence number of a segment which is finally received without loss.

19. The apparatus as claimed in claim 18, wherein the bit array represents virtual blocks corresponding to segments from the sequence number of a first non-acknowledged segment to the individual ACK.

20. The apparatus as claimed in claim 15, wherein the BBACK further comprises a field representing a kind and length of the BBACK, and granularity information representing a size of the virtual block.

21. The apparatus as claimed in claim 15, wherein the BBACK is included in an option field of a TCP header.

22. A computer program embodied on a computer-readable medium for transmitting virtual block information for multiple segment recovery in a data network using a TCP, comprising:
a first set of instructions for generating a bitwise block ACK (BBACK) including virtual block information comprising a bit array, each bit of which represents a virtual block of a predetermined size and wherein each bit is set to a first value when a corresponding virtual block overlaps a loss block of a physical stream; and
a second set of instructions for controlling a device for transmitting the BBACK.

23. The computer program embodied on a computer-readable medium as claimed in claim 22, wherein the first value is ‘1’.

24. A computer program embodied on a computer-readable medium for receiving virtual block information for multiple segment recovery in a data network using a TCP, comprising:
a first set of instructions for controlling a device for receiving a bitwise block ACK (BBACK) including virtual block information comprising a bit array, each bit of which represents a virtual block of a predetermined size and wherein each bit is set to a first value when a corresponding virtual block overlaps a loss block of a physical stream;
determining if all of the bits of the bit array are a second value; and
retransmitting a virtual block represented by a bit set to the first value of the bit array if all of the bits of the bit array are not the second value.

25. The computer program embodied on a computer-readable medium as claimed in claim 24, wherein the first value is ‘1’ and the second value is ‘0’.
